(19) United States
(12) Patent Application Publication
(10) Pub. No.: US 2024/0190263 A1
(43) Pub. Date: Jun. 13, 2024

(54) Control Device for Operating a Road-Coupled All-Wheel Drive Vehicle

(71) Applicant: Bayerische Motoren Werke Aktiengesellschaft, Muenchen (DE)

(72) Inventors: Thomas EBERL, Sauerlach (DE); Florian SCHNAPPAUF, Hattenhofen (DE)

(21) Appl. No.: 18/288,046

(22) PCT Filed: Apr. 6, 2022
(86) PCT No.: PCT/EP2022/059064

§ 371 Date: Oct. 24, 2023

(30) Foreign Application Priority Data
May 12, 2021 (DE) 10 2021 112 440.9

(51) Int. Cl. B60L 15/20; B60L 3/00; B60L 3/10

(52) U.S. Cl. CPC B60L 15/2036; B60L 3/0061; B60L 3/10; B60L 2240/423; B60L 2240/425; B60L 2250/26

(57) ABSTRACT

A control device for operating a road-coupled all-wheel drive vehicle, includes at least one electronic control unit, at least one first electric drive motor as a primary motor assigned to a primary axle and at least one second electric drive motor as a secondary motor assigned to a secondary axle. The control unit has a torque-limiting module which, if an expected change of the all-wheel drive factor is detected which can lead to a transition from single-axle operation to dual-axle operation on the basis of a defined signal that runs ahead the filtered driver's request signal, the torque limits for the individual target torques of the electric drive motors can be preset in a sudden manner according to the predetermined changed all-wheel drive factor before the individual target torques per se are set.

### BACKGROUND AND SUMMARY

The invention relates to a control device for operating a road-coupled all-wheel drive vehicle, having at least one electronic control unit, having a first electric drive motor assigned to a primary axle (for example, rear axle) and having a second electric drive motor assigned to a secondary axle (for example, front axle).

For example, DE 10 2014 200 427 A1 makes known a road-coupled hybrid vehicle that includes two different drive units on the particular axle. The different drive units, in particular an internal combustion engine and an electric drive motor, have different dynamic properties; i.e., the target torques are not providable equally quickly at the individual axles. In particular, an increase in torque can be carried out considerably faster by means of an electric drive motor than the same torque increase can be carried out by means of an internal combustion engine. The electronic control unit known from DE 10 2014 200 427 A1 deals in particular with problems of these different drive units.

In a road-coupled all-wheel drive vehicle, the primary motor and the secondary motor are not drivingly coupled via a clutch, but rather merely by means of the road via the wheels. Such road-coupled all-wheel drive vehicles are also referred to as “axle-split” vehicles. Such all-wheel drive vehicles are usually operated in a first operating mode (preferably an efficiency-optimized drive mode) solely with the primary motor (single-axle operation) and are also operable as an all-wheel drive vehicle using both drive motors (dual-axle operation) in a second operating mode (preferably a performance-optimized drive mode), in which the secondary motor is automatically switchable on and off.

In the following, the “electric drive motor” is also referred to in short as an “electric motor”, and the “drive torque” is also referred to in short as “torque”.

One problem addressed by the invention is that of improving an all-wheel drive vehicle of the aforementioned type with respect to performance, efficiency, and comfort.

This problem is solved according to the invention by the subjects of the independent claims. Dependent claims are advantageous enhanced embodiments of the invention.

The invention relates to a control device for operating a road-coupled all-wheel drive vehicle, having at least one electronic control unit, having at least a first electric drive motor as a primary motor assigned to a primary axle and having at least a second electric drive motor as a secondary motor assigned to a secondary axle. According to the invention, the control unit comprises a torque-limiting module which, upon detection of an expected change in the all-wheel drive factor on the basis of a defined signal that precedes the filtered driver-input signal, the torque limits for the individual target torques of the electric drive motors are abruptly preset according to the predetermined changed all-wheel drive factor before the individual target torques per se are set.

Preferably, the torque-limiting function is carried out for the case in which a change in the all-wheel drive factor is present upon detection of a defined dynamic driving mode of the driver, for example, on the basis of the gradient of the unfiltered raw signal of the accelerator pedal sensor, and, as a result, a torque limitation for the individual target torques is necessary.

Preferably, the unfiltered raw signal of the accelerator pedal sensor (in particular in the case of a dynamic driving mode of the driver) or the detection of a slip situation or an overheating of the primary motor is defined as the signal that precedes the filtered driver-input signal.

The torque-limiting function constantly calculates and digitally changes the limits (torque limits) at any time when the all-wheel drive factor changes (in the direction of dual-axle operation and also in the direction of single-axle operation) and the limits of the target torque have (still) not been retrieved. Therefore, also in part-load operation or in the coasting condition, when the information for the traction operation changes, vice versa also in traction operation, when the information for the coasting condition changes. The main area of application is preferably a “tip in” (as defined in greater detail below, i.e., in a defined dynamic driving mode of the driver), i.e., for the case in which the limits of the target torque (or of the particular individual target torque) are approached and there is a redistribution.

The invention is based on the following considerations:

The invention relates to the distribution of drive power, in particular after a change in the driver input that results in a transition from the single-axle driving operation to a dual-axle (all-wheel) driving operation, in which an all-wheel drive factor (AWD) specifies the ratio of the target torque distribution onto the e-machine(s) per axle.

This relates to a strategy for automatically engaging the electric secondary motor in the presence of a similarly electric primary motor and to a strategy for changing the target torque of the primary motor upon transitioning from single-axle operation to dual-axle operation. In the related art, driving stability-oriented travel with distribution of drive torque onto the axles for increasing traction is usually emphasized. The invention, however, primarily deals with increasing comfort by preventing noticeable jolts.

For example, DE 10 2021 105 341, which was not previously published, already describes a control device for operating a road-coupled all-wheel drive vehicle, having at least one electronic control unit, having a first electric drive motor (primary motor) assigned to a primary axle and having a second electric drive motor (secondary motor) assigned to a secondary axle. This control unit includes a dynamic function module designed such that, upon detection of a defined dynamic driving mode of the driver on the basis of the driver-input gradient during a (single-axle) operating mode with the primary motor activated and the secondary motor deactivated for a predefined time window, a total target torque curve predefined by the new driver input is ascertained. The total target torque curve is set, in accordance with an axle distribution factor that is also predefined, by reducing the target torque of the primary motor and by activating and increasing the target torque of the secondary motor, even when the predefined total target torque curve is below a maximum possible torque of the primary motor.

In the event of a required activation of the secondary motor starting from a switched-off magnetic field of the secondary motor, the necessary magnetization time is predetermined as the predefined delay time. The primary motor solely provides the required total target torque for the duration of this delay time. Only then are the target torques of both electric drive motors synchronously set in accordance with a predefined all-wheel distribution factor.

A defined dynamic driving mode of the driver is preferably detected on the basis of the driver-input gradient when the current driver-input gradient exceeds a predefined threshold value.

The predefined total target torque curve is preferably determined depending on the driver-input gradient and depending on the difference between the target torque predefined by the driver input and the currently available torque of the primary motor.

In order to improve such road-coupled electric all-wheel drive systems, the present invention relates to a power coordination for the targeted distribution of the drive power of the energy source (e.g., HV battery) to two axles, each of which has an e-machine, which prevents uncomfortable jolts when, for example, a new desired all-wheel distribution (“all-wheel drive factor”) could be requested in each sampling task.

If (at least) one e-machine is installed on each axle, it being possible to allocate more power to all these e-machines jointly than the battery source (for example, a high-voltage battery) could deliver, a certain limited power must be allocated in a targeted manner to each e-machine per axle.

This limiting power allocation is converted, according to the invention, into torque limits, in principle, by way of appropriate programming of the control unit. In order to prevent jolts, these torque limits could be “approached” in a ramped manner. This can briefly result in unintentional all-wheel distributions due to power shifts, however.

The driver power input is detected, in principle, as summation target torque from the filtered accelerator pedal sensor signal. Depending on this filtered summation target torque, an all-wheel drive factor is determined, which yields the individual target torques of the axles and the e-machines, which are then comfortably set via the e-machines, for example, by means of a “fader”. A fader is understood to be a suitable all-wheel drive fade-over function in the event of a change in an all-wheel drive factor.

In the event of a rapid change in the summation target torque (for example, in the event of an abrupt demand for full load out of the coasting operation, which is also referred to as “punch” or “tip in”), a jolt can occur, since the e-machine of the primary axle initially overshoots starting from single-axle operation before the comparatively slow all-wheel drive fade-over function specifies the new torque limits for dual-axle operation.

Therefore, according to the invention, due to a defined signal (unfiltered target path), which enables an upcoming rapid change in the all-wheel drive factor to be inferred more quickly than the filtered summation target torque (filtered target path), the torque limits for the upcoming all-wheel drive factor are digitally (i.e., abruptly and not in a ramped manner) specified, i.e., before the individual target torques of the e-machines are actually set for the upcoming al-wheel drive factor.

In other words, the power that is not yet approached by the slower filtered target path is digitally distributed, due to a faster unfiltered target path, in the desired all-wheel drive factor ratio under consideration of the particular maximum power characteristic curve per e-machine. If the filtered target path then approaches the distributed power, it has already been correctly distributed due to the previously set torque limits.

The unfiltered target path can preferably be the raw signal of the accelerator pedal sensor. The unfiltered target path can also be the detection of a slip situation or an overheating of the e-machine of the primary axle.

The use of the unfiltered target path as preparation for the redistribution, in particular at a transition from single-axle operation to dual-axle operation, therefore proceeds from the filtered target path, as a result of which the new all-wheel drive factor can be transmitted to the power coordination before the power is actually approached depending on the filtered target path.

The invention relates in particular to an all-wheel driving strategy with respect to unsteady processes for electrified vehicles having two electric drive motors, namely a first electric (drive) motor on a primary axle and a second electric (drive) motor for a secondary axle.

For reasons of efficiency, it can be meaningful in the case of electrified all-wheel drive vehicles to travel for as long as possible in single-axle operation (rear-wheel drive or front-wheel drive). The axle driven in the preferably single-axle operation is referred to as the primary axle.

In a dynamic (“unsteady”) driving mode, it is meaningful for reasons of performance to engage the second axle (secondary axle) early in order to generate a sporty performance response (also referred to as “response” or “punch”) of the vehicle. A dynamic driving mode is detected in particular on the basis of a steep gradient of the accelerator pedal actuation (also referred to as “tip in”).

In particular after a tip-in detection, the total target torque is set by means of the two electric motors on both axles by means of a predefined axle distribution factor. The target torque of the primary motor is decreased and the target torque of the secondary motor is increased.

Due to the invention, the setting of the total torque no longer solely has the highest priority. Rather, the optimal distribution of the axle torques is also taken into account with respect to efficiency, performance and comfort.

Details of the invention are explained in greater detail in the following exemplary embodiments on the basis of the drawings.

### BRIEF DESCRIPTION OF THE DRAWINGS

FIG. 1 is a schematic view of a road-coupled electric all-wheel drive vehicle according to an embodiment of the invention including components that are essential to the torque-limiting function according to the invention;

FIG. 2 is a diagram representation of the technical problem without the control device according to the invention; and

FIG. 3 is a diagram representation of one possible approach according to the problem represented in FIG. 2.

### DETAILED DESCRIPTION OF THE DRAWINGS

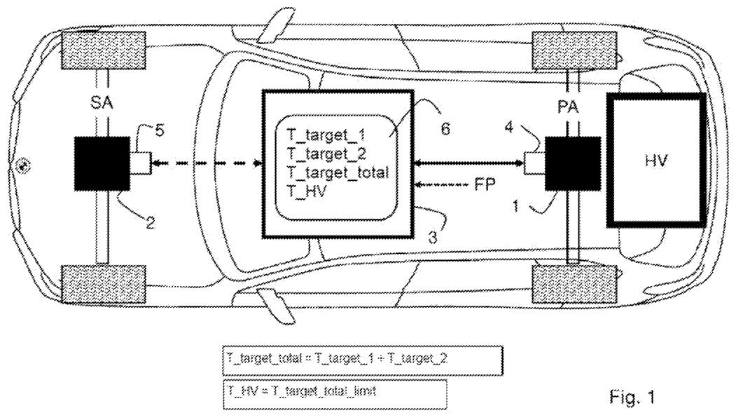

FIG. 1 shows a road-coupled all-wheel drive vehicle having a first electric motor 1 as a primary motor, which acts as a drive motor, for example, on the rear axle PA, and having a second electric motor 2 as a secondary motor, which acts as a drive motor on the front axle SA as a secondary axle in dual-axle operation. The electric motors 1 and 2 are also referred to as electric machines or e-machines. The total output or the total torque of the two e-machines (T_target_total=T_target_1+T_target_2) is predefined by a filtered driver-input signal AP_int and delimited by the maximum possible output of a high-voltage battery HV: T_HV=T_target_total_limit.

The primary motor 1 can include a separate mechatronically connected sub-control unit 4 and the secondary motor 2 can include a separate mechatronically connected sub-control unit 5. Both sub-control units 4 and 5 are connected to a central electronic control unit 3.

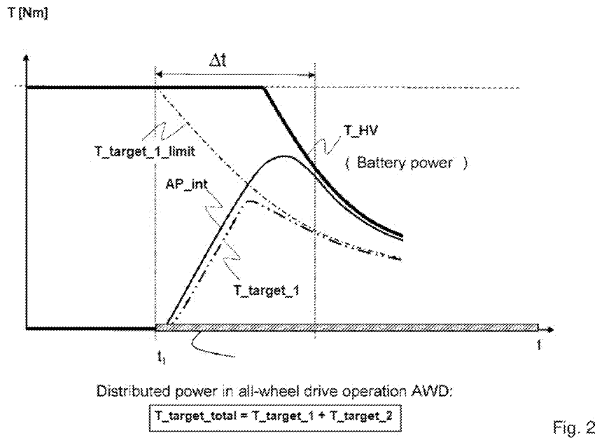

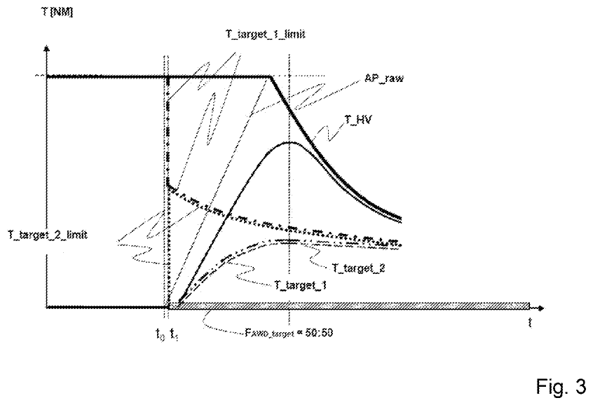

A method for controlling the operation of the electric all-wheel drive vehicle is carried out by the central electronic control unit 3, which has an appropriate programmable function module 6 and connections to the necessary sensors, actuators and/or to the optional sub-control units 4 and 5. According to the invention, the control unit 3 includes a torque-limiting function module 6, for example, in the form of a software program (computer program product), the design and mode of operation of which will be described in greater detail in the description of FIGS. 2 and 3.

FIG. 2 shows, also representatively for FIG. 3, a diagram with the time t plotted on the x-axis and the torque M plotted on the y-axis. The thick solid line shows the battery power as maximum possible power T_HV. The thin solid line represents the driver input in the form of a filtered summation target torque AP_int on the basis of the accelerator pedal position, in this case at a transition from zero or a coasting operation to full load (“punch” or “tip in”). This driver input AP_int corresponds to the ascertained total target torque curve T_target_total. Due to the “punch” or “tip in” situation represented here, the transition from single-axle operation to dual-axle operation takes place at the point in time t1 with the predetermined all-wheel drive factor F_{AWD_target} (for example, 50:50).

As shown in FIG. 2, without the digital torque-limiting function module 6 according to the invention, the predefined torque limitation T_target_1_limit for the primary motor 1 would be reduced in a ramped manner, as a result of which the target torque T_target_1 of the primary motor 1 would initially increase in a comparatively jerky manner and would be slowly reduced only once the secondary motor 2 starts up (not shown here in greater detail, because this is not relevant to comfort). Once a fade-over time Δt has elapsed, the predefined all-wheel drive factor F_{AWD_target} (for example, 50:50) is reached in a delayed manner.

The target torque T_target_1 of the primary motor 1 is indicated by a dash-double dotted line. The maximum torque that can be provided by the primary motor 1 is designated as T_target_1_limit.

The diagram according to FIG. 2 initially shows a coasting operation having an all-wheel distribution factor of F_{AWD_target}=100:0. The torque T_target_2 is zero, since the secondary motor 2 is initially shut off.

At the point in time t1, dynamic driver input (tip-in situation) is detected on the basis of the steep gradient of the accelerator pedal position AP_int.

In FIG. 3, the torque-limiting function module 6, which is essential to the invention, is explained in greater detail:

A torque-limiting function can be carried out due to an appropriate design or programming of the torque-limiting module 6. Upon detection of an expected change in the all-wheel drive factor F_{AWD_target}—in this case from 100:0 to 50:50—at a point in time to, which is shortly before the point in time t1, due to a defined signal, namely the unfiltered raw signal AP_raw of the accelerator pedal sensor, which precedes the filtered driver-input signal AP_int, the torque limits T_target_1_limit and T_target_2_limit for the individual target torques T_target_1 and T_target_2 of the electric drive motors 1 and 2 are abruptly preset according to the predetermined changed all-wheel drive factor F_{AWD_target} 50:50 before the individual target torques T_target_1 and T_target_2 per se are set.

For example, the torque-limiting function according to the invention can be carried out only for the case in which a change in the all-wheel drive factor F_{AWD_target} is detected in the sense of a transition from single-axle operation to dual-axle operation, in particular upon detection of a defined dynamic driving mode of the driver on the basis of the gradient of the unfiltered raw signal AP_raw of the accelerator pedal sensor during single-axle operation.

1.-5. (canceled)

6. A control device for operating a road-coupled all-wheel drive vehicle, comprising:
at least one electronic control unit;
at least a first electric drive motor as a primary motor assigned to a primary axle; and
at least a second electric drive motor as a secondary motor assigned to a secondary axle,
wherein the control unit comprises a torque-limiting module which, upon detection of an expected change in an all-wheel drive factor (F_{AWD_target}) on the basis of a defined signal (AP_raw) that precedes a filtered driver-input signal (AP_int), torque limits (T_target_1_limit, T_target_2_limit) for individual target torques (T_target_1, T_target_2) of the first and second electric drive motors are abruptly preset according to the predetermined changed all-wheel drive factor (F_{AWD_target}) before the individual target torques (T_target_1, T_target_2) per se are set.

7. The control device according to claim 6, wherein
unfiltered raw signal (AP_raw) of an accelerator pedal sensor (FP) or detection of a slip situation or an overheating of the primary motor is defined as the signal that precedes the filtered driver-input signal (AP_int).

8. The control device according to claim 6, wherein
the torque-limiting function is carried out for a case in which a change in the all-wheel drive factor is present upon detection of a defined dynamic driving mode of the driver and, as a result, a torque limitation of the individual target torques (T_target_1, T_target_2) is necessary.

9. An electronic control unit, comprising:
a torque-limiting module that:
at least one electronic control unit;
at least a first electric drive motor as a primary motor assigned to a primary axle; and
at least a second electric drive motor as a secondary motor assigned to a secondary axle,
wherein the control unit comprises a torque-limiting module which, upon detection of an expected change in an all-wheel drive factor (F_{AWD_should}) on the basis of a defined signal (FP_roh) that precedes a filtered driver-input signal (FP_int), torque limits (M_should_1_limit, M_should_2_limit) for individual target torques (M_should_1, M_should_2) of the first and second electric drive motors are abruptly preset according to the predetermined changed all-wheel drive factor (F_{AWD_should}) before the individual target torques (M_should_1, M_should_2) per se are set.

10. A computer product comprising a non-transitory computer readable medium having stored thereon program code that, when executed in the electronic control unit, carries out the acts of:
at least one electronic control unit;
at least a first electric drive motor as a primary motor assigned to a primary axle; and
at least a second electric drive motor as a secondary motor assigned to a secondary axle,
wherein the control unit comprises a torque-limiting module which, upon detection of an expected change in an all-wheel drive factor (F_{AWD_target}) on the basis of a defined signal (AP_raw) that precedes a filtered driver-input signal (AP_int), torque limits (T_target_1_limit, T_target_2_limit) for individual target torques (T_target_1, T_target_2) of the first and second electric drive motors are abruptly preset according to the predetermined changed all-wheel drive factor (F_{AWD_target}) before the individual target torques (T_target_1, T_target_2) per se are set.
